(19) United States
(12) Patent Application Publication
(10) Pub. No.: US 2014/0052816 A1
(43) Pub. Date: Feb. 20, 2014

(54) NETWORK MATCHMAKING SYSTEM

(71) Applicant: NATIONAL TAIWAN UNIVERSITY OF SCIENCE AND TECHNOLOGY, Taipei City (TW)

(72) Inventors: Shiow-Yang Wu, Taipei City (TW); Ge-Ming Chiu, Taipei City (TW); Tai-Lin Chin, Taipei City (TW); Tien-Ruey Hsiang, Taipei City (TW)

(21) Appl. No.: 13/872,838

(22) Filed: Apr. 29, 2013

(30) Foreign Application Priority Data
Aug. 20, 2012 (TW) 101130087

(51) Int. Cl. H04L 29/08

(52) U.S. Cl. CPC H04L 67/306
USPC 709/217

(57) ABSTRACT

The present invention discloses a network matchmaking system, capable of matching at least one provider with at least one demander via internet. The subject matter of the matching process can be determined automatically by the system of the present invention, meanwhile, no predetermined setting of the subject matter of the matching process is required by both provider and the demander. The network matchmaking system of the present invention comprises a first terminal, a second terminal and a network server. The first terminal and the second terminal are utilized to continuously capture a raw data respectively for the network server to generate two corresponding habit data. Accordingly, the network server is capable of matching the provider with the demander according to the habit data in real time with no predetermined setting required.

### PRIORITY CLAIM

This application claims the benefit of the filing date of Taiwan Patent Application No. 101130087, filed Aug. 20, 2012, entitled “NETWORK MATCHMAKING SYSTEM,” and the contents of which is hereby incorporated by reference in its entirety.

### FIELD OF THE INVENTION

This invention relates to a network matchmaking system, and more particularly, to the network matchmaking system capable of automatically matching the provider and the demander by capturing the users' habits.

### BACKGROUND OF THE INVENTION

With the development and popularization of the internet technology, various electronic transaction platforms for teleshopping, electronic group buying, or electronic carpooling are introduced and spread. The most popular one in the electronic transactions might be the matchmaking for users. The matchmaking means not only providing the users and the product provider with the service for group buying, but also including the searching platform of demand for products and services.

When using the electronic transaction platforms for matchmaking, a user (the provider or the demander) should set the product or the service which is needed or can be provided so that the electronic transaction platforms can provide the matchmaking. Taking the group buying platform for an example, if the vendor wants to provide a service, he needs to fill out the data related to the service or the product. On the other side, the buyer needs to fill out keywords to search the product or the preference. However, the procedure of the data filling makes the vendor or the buyer inconvenient.

Taking the carpooling websites for example, it is usually built up for peer groups or others of specific relationships, but unsuitable for the dynamic community based on transient common objectives or benefits.

Therefore, a novel, efficient, and simple matchmaking platform is needed for solving the above-mentioned problems.

### SUMMARY OF THE INVENTION

One object of the present invention is to provide a network matchmaking system to solve the problem in the prior art.

According to an embodiment of the invention, the network matchmaking system is used for matching users via the internet. The system includes at least one first terminal, at least one second terminal, and a network server. The first terminal continuously captures a first coordinate according to a first location of a first user, and the second terminal continuously captures a second coordinate according to a second location of a second user. The network server is connected to the first terminal and the second terminal via internet network and continuously receives the first coordinate and the second coordinate from the first terminal and the second terminal to generate a first path habit and a second path habit. The network server is capable of respectively matching the first terminal and the second terminal according to the first coordinate, the second coordinate, the first path habit, and the second path habit.

The firs terminal and the second terminal can be a first mobile phone respectively. The first terminal and the second terminal also can include a provider interface for a provider and a demander interface for a demander. Besides, the first terminal and the second terminal respectively capture the first coordinate and the second coordinate by utilizing a global positioning system or a station positioning system. The first path habit and the second path habit respectively include a coordinate data and a time date. The network matchmaking system manages and matches the first terminal and the second terminal by utilizing a dynamic group technology.

According to another embodiment of the invention, the system includes a first terminal, a second terminal, and a network server. The first terminal continuously captures a first trade data from a first user, and the second terminal continuously captures a second trade data from a second user. The network server is connected to the first terminal and the second terminal via an internet network and continuously receives the first trade data and the second data from the first terminal and the second terminal respectively to generate a corresponding first trading habit and a corresponding second trading habit. The network server is capable of respectively matching the first terminal and the second terminal according to the first trade data, the second trade data, the first trading habit, and the second trading habit.

The first terminal and the second terminal can be a personal computer respectively. The first trade data and the second trade data can include an item name and a corresponding price respectively. The first trade data and the second trade data can include a trading record and a credit record respectively. Besides, the first trade data includes a group buying data.

According to another embodiment of the invention, the network matchmaking system is used for matching users via the internet. The system includes a first terminal, a second terminal, and a network server. The first terminal continuously captures a first coordinate according to a first location of a first user, and the second terminal continuously captures a second trade data. The network server is connected to the first terminal and the second terminal via internet network, and continuously receives the first coordinate and the second trade data from the first terminal and the second terminal. The network server is capable of automatically judges an action type of the first user according to the first coordinate and a trading type of the second user according to the second trade data, and matches the first terminal and the second terminal according to the action type, the first coordinate, and the second trade data. The network matchmaking system manages and matches the first terminal and the second terminal by utilizing a dynamic group technology.

As described above, the present invention provides a network matchmaking system for automatically matching the provider and the demander by capturing the users' habit.

On the advantages and the spirit of the invention, it can be understood further by the following invention descriptions and attached drawings.

### BRIEF DESCRIPTION OF THE DRAWINGS

FIG. 1 is a schematic drawing illustrating a network matchmaking system according to an embodiment of the invention.

FIG. 2 is a schematic drawing illustrating a carpooling plan according to an embodiment of the invention.

### DETAILED DESCRIPTION

This invention is to provide a network matchmaking system capable of matching users via internet network. In brief, the network matchmaking system automatically matches the provider and the demander by capturing the users' habits without setting the matching data by the users.

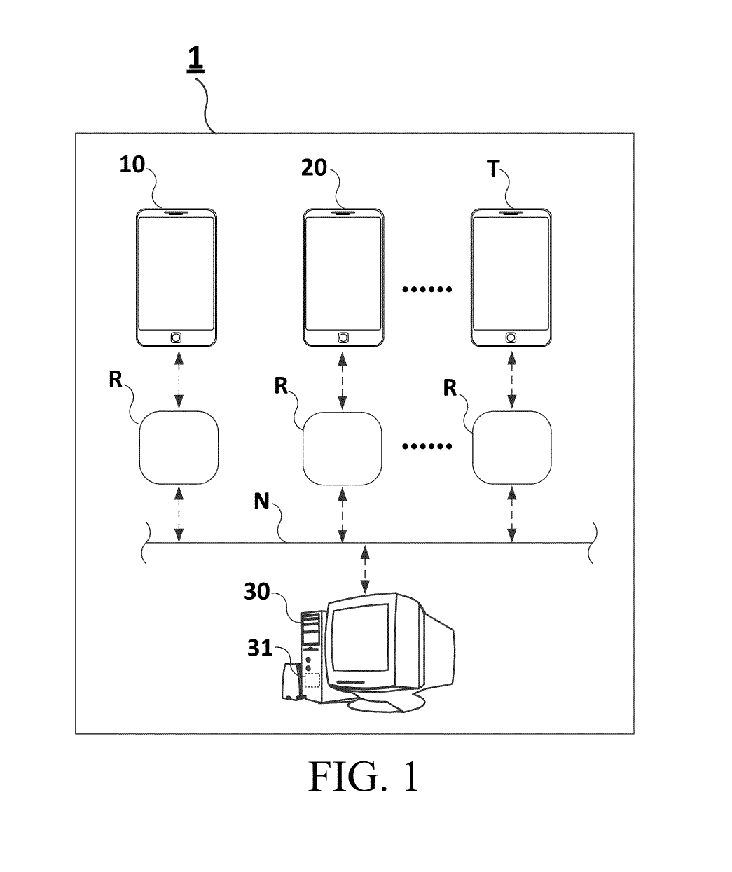

Please refer to FIG. 1. FIG. 1 is a schematic drawing illustrating a network matchmaking system according to an embodiment of the invention. As shown in FIG. 1, the network matchmaking system 1 includes a network server 30, a first terminal 10, and a second terminal 20. It should be noted that the network matchmaking system 1 can not only includes two but many terminals according to the requirement of the user in practice, such as first terminal 10, the second terminal 20, the terminal T, and others shown in FIG. 1.

The first terminal 10 and the second terminal 20 can be any electronic device having access ability to the internet network N, such as a mobile phone, a personal computer, a notebook computer, a tablet computer, a global positioning system, or a car computer. It should be noted that each of the terminals in the present invention can be connected to the internet network N by any means besides the wireless base station R such as a wire or wireless router indoor.

In this embodiment, the first terminal 10 and the second terminal 20 are mobile phones capable of being carried by a first user and a second user respectively, and connected to the internet network N and the network server 30 through the wireless base station R. The first terminal 10 and the second terminal 20 can respectively capture the a first coordinate and a second coordinate according to the locations of the first user and the second user by utilizing the global positioning system (GPS) and the station positioning system, and then transfer then to the network server 30. The network server 30 includes a filter module 31 or a corresponding filter program to analyze and filter the first coordinate and the second coordinate by a preset condition, so as to obtain or generate a first path habit and a second path habit correspondingly. The first path habit and the second path habit would be stored in the network server 30 for the follow-up procedure.

For example, the filter module of the network server 30 can be applied with data mining technique, and obtain the information about the start point, the end point, the path, and the time by comparing and training. However, the start point, the end point, the path, and the time can be judged according to the judging formation including variables such as the time, distance, and pattern of moving besides the data mining technique. The first path habit and the second habit respectively include a record composed of a coordinate data and a time date.

In practice, the network server 30 respectively matches the first terminal 10 and the second terminal 20 in real time according to the first coordinate, the second coordinate, and the corresponding path habits.

For example, the first user can be a driver who travels back and forth between place A and place B everyday, and he looks for carpooling to share the oil cost. The second user looks for carpooling to the place B. When the first user arrives a certain point, the network server 30 knows that the distance between the first user and the second user is less than a preset distance according to the coordinates of the first user and the second user, and then compares the path habits to know the goals of the first user and the second user are close. Therefore, the network server 30 matches the first user and the second user. The other users near the first user but having different paths would not be shown in this case. On the other hand, the network server is capable of knowing each point on the first path of the first user, so that the start points and the end points of the first user and the second user are not necessary the same. In detail, if the first user wants to travel from place A to place B and the second user wants to travel from the place A to place C, between the place A and place B, the system may match the second user with the first user and the first user on condition that there is no other closer match, and the first user has the right to decide to receive the match or not.

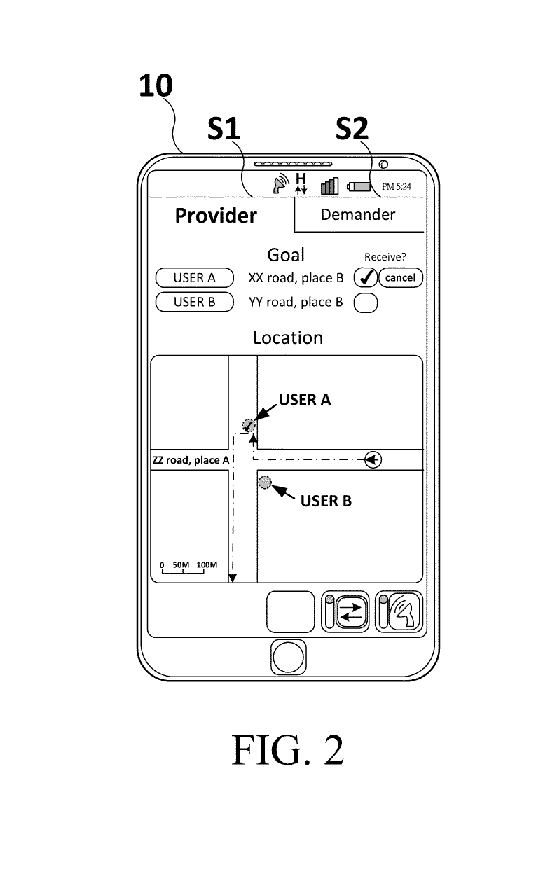

Please refer to FIG. 2. FIG. 2 is a schematic drawing illustrating a carpooling plan according to an embodiment of the invention. When the network server 30 matches the first user and the second user, the first terminal 10 and the second terminal 20 respectively show the address or coordinate of goals or other corresponding location information of the first user and the second user, and provide an option for receiving the carpooling. Once the first user and the second receive the carpooling, the network server 30 passes identifying means, such as the vehicle identification number or the picture, to the first user and the second user for identifying each other. The address or coordinate of goals or other location information can be shown in the forms of characters or a mark on a map. It should be noted that the first user and the second user are not necessary to set the start points or the goals by themselves, and the system manages all the processes of the match. To raise the success rate of the match, the network server 30 of the invention is capable of estimating the possibility of the match by the area. In detail, the case that the distance between the first user and the second user is larger than a preset distance will be filtered automatically to prevent the users from inconvenience.

It should be noted that the network server 30 of the invention can be further integrated in the carpooling platform, the positioning software, the navigating software, or other application programs in the prior art to achieve better efficiency.

The first terminal 10 and the second terminal 20 of the network matchmaking system 1 further include a provider interface S1 and a corresponding demander interface S2 respectively. The system judges that the user provides a product or a service when the user switches to the provider interface S1, and the system judges that the user demands a product or a service when the user switches to the demander interface S2. In this embodiment, the provider interface S1 is for the driver providing a carpooling service, and the demander interface S2 is for the user who needs to join carpooling. For another embodiment, the network matchmaking system 1 can be used in a network transaction platform besides the carpooling match. In this embodiment, the first terminal 10 can be a product or service provider, and the second terminal 20 can be a product or service demander. In practice, the first terminal 10 and the second terminal 20 continuously capture a first trade data and a second data respectively according to the browsing record (such as cookies or text file), trading record, or credit record, and then transfer the first trade data and the second data to the network server 30 with the authorization of the users. The network server 30 analyzes and filters the first trade data and the second trade data by a preset condition after receiving to correspondingly generate and store a first trade habit and second trade habit.

In practice, the network server 30 respectively matches the first terminal 10 and the second terminal 20 according to according to the first trade data, the second trade data, the first trading habit, and the second trading habit. For example, the first user can be a seller selling a first product with a first price, and the second user can be a buyer. The first terminal 10 collects the selling record of the first product as the first trade data and transfers it to the network server 30 when the first user sells the first product, and the network server 30 correspondingly generates a first trade habit according to the first trading data. On the other hand, the second terminal 20 collects the buying record of the second user as the second trade data and transfers it to the network server 30 when the second user shop via the second terminal 20, and the network server 30 correspondingly generates a second trade habit according to the second trading data.

At another shopping of the second user, the system matches the first user to the second user when the second user searches or browses the website about the first product. In practice, if the website browsed by the second user lists the price of the product, the network server 30 can compare the price provided by the first user with the price listed on the website, and then provide the information of the first user on condition that the price provided by the first user is less. The network server 30 also checks the latest first trade data before providing it to the second user, to confirm whether the product or the service sold out or closed.

The first user can be not only the provider of the product or the service but also an originator of group buying, and the product should be the group buying service.

To achieve the above-mentioned matching functions, the network matchmaking system can manage and match the first terminal and the second terminal by utilizing a dynamic group technology. In detail, the dynamic group technology integrates the features such as moving trace, moving trend, moving sequence, or purchasing power of many users, and then generates a user group by the combination of the demands such as amount of the user, price range, trade place, trade time, trade content, and trace. The members in a dynamic group are not necessary connected to each other via a social network or knowing the others' identifications. The members only need to contribute to keep the dynamic group existing, such as getting close to the trade place, retaining purchasing power or shopping will. The invention matches the users and maintains the forming and joining of the users by analyzing the dynamic property of the users. A dynamic group includes a plurality of participator, a plurality of users corresponding to the first terminals and the second terminals. One user can join many dynamic groups with different conditions at the same time.

The invention includes an actively maintaining function of the dynamic group besides automatic establishing and matching functions. The dynamic group has the sequence function and reactive ability. In detail, the system of the invention matches the users by the coordinates and habits, and further judges the consumer's behavior by integrating the coordinates and habits, so as to match the service according to the area and the behavior of the user.

For example, the network server continuously captures the first coordinate to know that the user moves for a long time in a sports ground, and the system judges that the user is exercising. The ice food service may attract the user after exercise, so that the system of the invention can automatically match the local merchants and the user and suggest the discount plan to the merchants. The system of the invention can automatically track and adjust the members of the dynamic group to satisfy the maximum group conditions with time effect.

As described above, the difference between the present invention and the prior art is that the invention provides a network matchmaking system capable of automatically matching the provider and the demander by capturing the users' habits, meanwhile, no predetermined setting by the users is required.

Although the present invention has been illustrated and described with reference to the preferred embodiment thereof, it should be understood that it is in no way limited to the details of such embodiment but is capable of numerous modifications within the scope of the appended claims.

1. A network matchmaking system, comprising:
a first terminal, continuously capturing a first coordinate according to a first location of a first user;
a second terminal, continuously capturing a second coordinate according to a second location of a second user; and
a network server, connected to the first terminal and the second terminal via internet network and continuously receiving the first coordinate and the second coordinate from the first terminal and the second terminal, and generating a first path habit and a second path habit according to the first coordinate and the second coordinate respectively;
wherein the network server respectively matches the first terminal and the second terminal according to the first coordinate, the second coordinate, the first path habit, and the second path habit.

2. The network matchmaking system of claim 1, wherein the first terminal and the second terminal respectively comprises a provider interface for a provider and a demander interface for a demander.

3. The network matchmaking system of claim 1, wherein the first terminal and the second terminal respectively capture the first coordinate and the second coordinate by utilizing a global positioning system or a station positioning system.

4. The network matchmaking system of claim 1, wherein the first path habit and the second path habit respectively comprises a coordinate data and a time date.

5. The network matchmaking system of claim 1, wherein the network matchmaking system manages and matches the first terminal and the second terminal by utilizing a dynamic group technology.

6. A network matchmaking system, comprising:
a first terminal, continuously capturing a first trade data from a first user;
a second terminal, continuously capturing a second trade data from a second user; and
a network server, connected to the first terminal and the second terminal via internet network and continuously receiving the first trade data and the second data from the first terminal and the second terminal, and generating a first trading habit and a second trading habit according to the first trade data and the second trade data respectively;
wherein the network server automatically matches the first terminal and the second terminal according to the first trade data, the second trade data, the first trading habit, and the second trading habit.

7. The network matchmaking system of claim 6, wherein the first trade data and the second trade data respectively comprises an item name and a corresponding price.

8. The network matchmaking system of claim 6, wherein the first trade data and the second trade data respectively comprises a trading record and a credit record.

9. The network matchmaking system of claim 6, wherein the network matchmaking system manages and matches the first terminal and the second terminal by utilizing a dynamic group technology.

10. A network matchmaking system, comprising:
a first terminal continuously capturing a first coordinate according to a first location of a first user;
a second terminal continuously capturing a second trade data from a second user; and
a network server, connected to the first terminal and the second terminal via internet network and continuously receiving the first coordinate and the second trade data from the first terminal and the second terminal respectively;
wherein the network server automatically judges an action type of the first user according to the first coordinate and a trading type of the second user according to the second trade data, and respectively matches the first terminal and the second terminal according to the action type, the first coordinate, and the second trade data by utilizing a dynamic group technology.
